(19) United States
(12) Patent Application Publication
(10) Pub. No.: US 2025/0031169 A1
(43) Pub. Date: Jan. 23, 2025

(54) ENHANCED IDLE AND CONNECTED MODE MOBILITY BETWEEN SNPNS

(71) Applicant: InterDigital Patent Holdings, Inc., Wilmington, DE (US)

(72) Inventors: Anuj Sethi, Ottawa (CA); Guanzhou Wang, Brossard (CA)

(73) Assignee: InterDigital Patent Holdings, Inc., Wilmington, DE (US)

(21) Appl. No.: 18/713,126

(22) PCT Filed: Jan. 27, 2023
(86) PCT No.: PCT/US23/11747

§ 371 Date: May 23, 2024

Related U.S. Application Data
(60) Provisional application No. 63/303,808, filed on Jan. 27, 2022.
(60) Provisional application No. 63/390,765, filed on Jul. 20, 2022.

(51) Int. Cl. H04W 60/04; H04W 36/06; H04W 76/30; H04W 84/04

(52) U.S. Cl. CPC H04W 60/04; H04W 36/06; H04W 76/30; H04W 84/042

(57) ABSTRACT

The wireless transmit/receive unit (WTRU) may comprise a processor and memory. The WTRU may be configured to send a registration request to a hosting network. The registration request may indicate at least one local service. The WTRU may receive a list of equivalent hosting networks for the at least one local service and a common tracking area identity (TAI) list for the list of equivalent hosting networks for the at least one local service. The WTRU may reselect between cells corresponding to equivalent hosting networks from the list of equivalent hosting networks without performing location updates based on the cells being associated with the common tracking area identity list. The WTRU may receive a registration accept message. The registration accept message may comprise the list of equivalent hosting networks for the at least one local service and the common tracking area identity list for the list of equivalent hosting networks for the at least one local service.

### CROSS-REFERENCE TO RELATED APPLICATIONS

This application claims the benefit of U.S. Provisional Patent Application No. 63/303,808, filed on Jan. 27, 2022, and to U.S. Provisional Patent Application No. 63/390,765, filed on Jul. 20, 2022, the entire contents of which are incorporated herein by reference.

### BACKGROUND

One or more non-public networks (NPNs) may be deployed for non-public use in a 5G system. An NPN can be implemented as a private mobile network where mobile services for dedicated and/or defined set of users or “things” (e.g., Internet or things (IoT) applications) that are part of a single organization or group of users. For example, an NPN may be a stand-alone non-public network (SNPN) or a public network integrated NPN (PNI-NPN). An SNPN may be operated by an NPN operator (e.g., without relying on network functions provided by a public land mobile network (PLMN)). A PNI-NPN may be a non-public network deployed with the support of a PLMN.

An NPN may be intended for the use of a private entity, such as an enterprise or a factory, for example. An SNPN may be identified by a combination of PLMN ID and network identifier (NID), where the PLMN ID may be a reserved PLMN ID for private networks (e.g., with Mobile Country Code being equal to 999). The architecture of a 5G SNPN is based on the architecture of a 5G system. NG-RANs of the SNPN may broadcast a combination of PLMN IDs and NIDs. A wireless transmit/receive unit (WTRU) operating in SNPN access mode reads the broadcast system information for available PLMN IDs and/or NIDs, and selects the SNPN for which it has subscription and credentials.

5G networks may provide access to localized services (PALS network). A small cellular network may be deployed to provide services to local users within a certain area. For example, a temporary non-public cellular network may be set up to provide streaming video service to the audience in a live concert or a football match. For another example, in places like airport, shopping mall and school campus, where a large crowd may gather, small cellular networks may be deployed to provide localized services, such as commercial ads in the shopping mall. The services provided by these small cellular networks have two basic characteristics: first, the services are localized (e.g., they are related to the activities/events in a certain spot or area, and are usually limited to the users within the area); second, the users do not utilize such services on a regular basis, but most likely in an on-demand or temporary fashion.

5G systems may be enhanced to provide such localized services, and users may be enabled to access the hosting network that provide those services. As used herein, such localized services may be referred to as “PALS service,” and the network that provides PALS services may be referred to as a “PALS network,” a “PALS hosting network,” and/or a “hosting network.” A hosting network may be an SNPN, a PNI-NPN, and/or a PLMN. The local service provider may be the hosting network operator or a 3^{rd}-party service provider.

### SUMMARY

A wireless transmit/receive unit (WTRU) may implement techniques for mobility and network selection related to one or more NPNs. For example, the WTRU may select a first cell associated with a first stand-alone non-public network (SNPN) and a first tracking area identifier (TAI) as part of a cell selection procedure. The WTRU may transmit a registration request message to the first SNPN. The WTRU may receive a registration accept message and a list of one or more TAIs from the first SNPN. The WTRU may select a second TAI from the list of one or more TAIs associated with a second cell that is associated with a second SNPN. The first SNPN and the second SNPN may be equivalent SNPNs. The list of one or more TAIs may include a first plurality of TAIs associated with the first SNPN and a second plurality of TAIs associated with the second SNPN. The WTRU may transition from the first cell to the second cell, for example without triggering a mobility registration procedure.

The wireless transmit/receive unit (WTRU) may comprise a processor and memory. The WTRU may be configured to send a registration request to a hosting network. The registration request may indicate at least one local service. The WTRU may receive a list of equivalent hosting networks for the at least one local service and a common tracking area identity (TAI) list for the list of equivalent hosting networks for the at least one local service. The WTRU may reselect between cells corresponding to equivalent hosting networks from the list of equivalent hosting networks without performing location updates based on the cells being associated with the common tracking area identity list. The WTRU may receive a registration accept message. The registration accept message may comprise the list of equivalent hosting networks for the at least one local service and the common tracking area identity list for the list of equivalent hosting networks for the at least one local service.

During cell reselection, a WTRU may change from one cell to another cell, and in some instance, stay in IDLE mode. For instance, the WTRU may be camped on (e.g., registered with) one cell (e.g., only one cell). When the WTRU determines that another cell is preferred (e.g., based on a measured signal strength of another cell), the WTRU may change to the other cell (e.g., and stay in IDLE mode). For example, the WTRU may reselect to a cell corresponding to an equivalent hosting network from the list of equivalent hosting networks based on a respective priority of each of the equivalent hosting networks (e.g., and/or based on measured signal strength of the other cell). Accordingly, during cell reselection, the WTRU may connect to a cell (e.g., of an equivalent hosting network) that has the best conditions among all the cells to which the WTRU is allowed to camp on.

The WTRU may receive a plurality of lists of equivalent hosting networks. Each of the lists of equivalent hosting networks of the plurality of lists of equivalent hosting networks may be associated with a respective one or more local service. The hosting network may comprise one of a register public land mobile network (RPLMN), a home public land mobile (HPLMN), or an equivalent HPLMN.

The WTRU may reselect between cells corresponding to the equivalent hosting networks form the list of equivalent hosting networks based on a respective priority of the hosting networks. The equivalent hosting networks may comprise one or more stand-alone non-public networks (SNPNs) or Hosting networks.

The WTRU may periodically attempt to find a highest priority equivalent hosting network during initial cell selection if the WTRU is not camped on the highest priority equivalent hosting network.

The WTRU may perform location updates comprises any combination of an initial registration at power on, a mobility registration procedure, and/or periodic updates. The initial registration at power on may include a location update and/or an attach procedure. The mobility registration procedure may include one or more of a location update, a routing area update, and/or a tracking area update. The periodic updates may be the periodic updates at expiry of the periodic registration timer. The periodic updates may include a period tracking and/or routing area update procedures.

A WTRU may connect to a first cell associated with a first SNPN. The WTRU may receive an RRC (Radio Resource Control) connection release message comprising idle mode mobility information from a network. The idle mode mobility information may include one or more NR carrier frequencies and respective NR (New Radio) operating bands. The WTRU may then enter an idle mode and select a second cell based on the idle mode mobility information. The WTRU may connect to the second cell.

The WTRU may receive an RRC connection release message from a registered hosting network that includes idle mode mobility information. The idle mode mobility information may comprise a list of carrier frequencies or an operating frequency band that belongs to the equivalent hosting networks. The WTRU may perform trigger cell selection or reselection based on a determination that a target frequency from the list of carrier frequencies meets cell selection and re-selection criteria.

A 5G core network node (e.g., an Access and Mobility Management Function (AMF)) may provide the list of TAIs that include TAIs from different SNPNs to one or more radio access (RAN) nodes. The RAN nodes may provide the list of TAIs to the WTRUs operating in cells supported by the RAN nodes. The WTRU may treat the different SNPNs as equivalent SNPNs for purposes of network selection, cell selection, cell re-selection, handover, and/or other types of mobility events. The 5G core network node (e.g., AMF) may provide Idle mode mobility info to WTRUs (e.g., via a RAN node(s)) for dedicated cell reselection. The idle mode mobility information may include dedicated NR carrier frequencies, NR Bands, etc. for different NR cells/RAN nodes. The idle mode mobility information may be common for a cell of NR cells/RAN nodes that belong to equivalent SNPNs for purposes of network selection, cell selection, cell re-selection, handover, and/or other types of mobility events.

A 5G core network node (e.g., an AMF) of a hosting network or registered PLMN (RPLMN)/home PLMN (HPLMN)/equivalent HPLMNs may provide a list of equivalent hosting networks per localized service supported. A WTRU may ensure that, during initial cell selection at power on or recovery from loss of coverage, the WTRU shall take into consideration priorities of the SNPNs/hosting networks. For example, the WTRU may try to select the highest-priority SNPN/hosting network (e.g., if it is available). The WTRU may make periodic attempts to find the highest priority network, for example, when the WTRU is not camped on the highest priority network.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A illustrates an example of equivalent hosting networks.

FIG. 2B illustrates an example usage of a tracking area identifier (TAI) list with one or more stand-alone non-public networks (SNPNs).

FIG. 3 illustrates an example usage of an RRC connection release with idle mode mobility information.

FIG. 4 illustrates an example of SNPN/hosting network selection and reselection based on priority.

### EXAMPLE NETWORKS FOR IMPLEMENTATION OF THE INVENTION

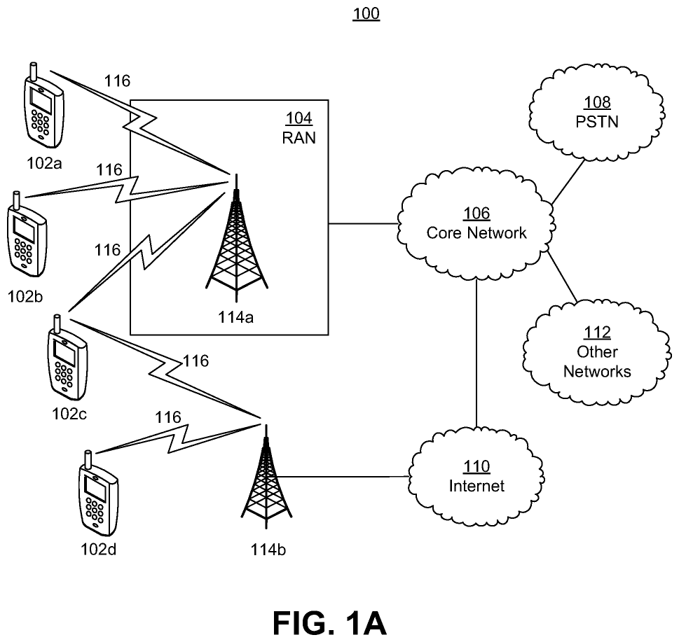

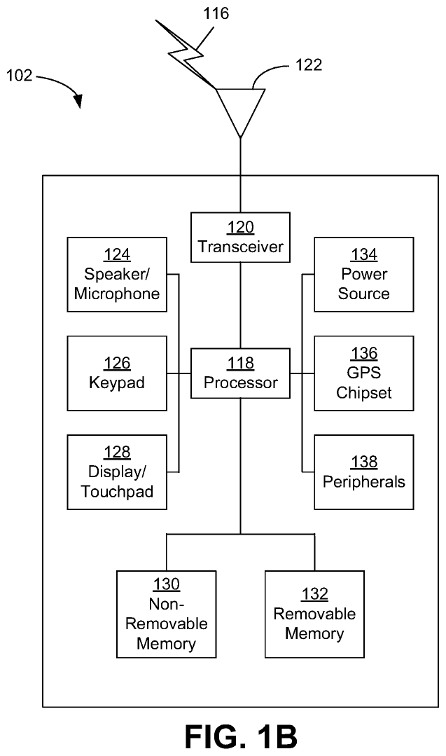

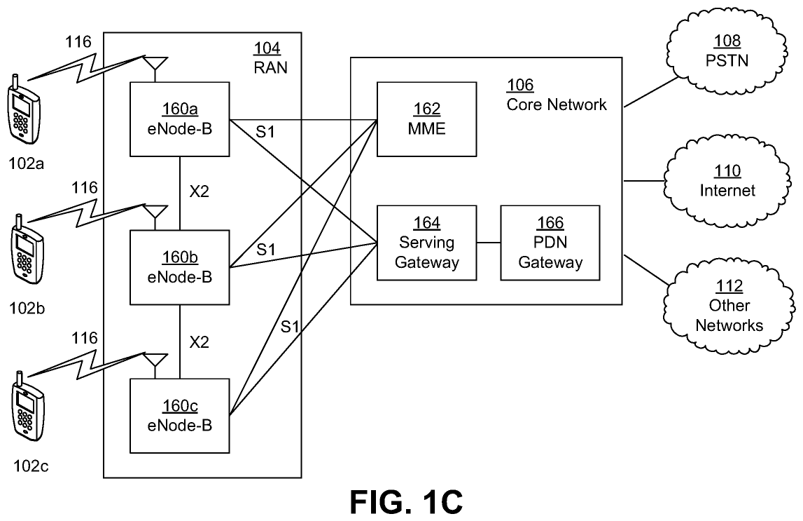

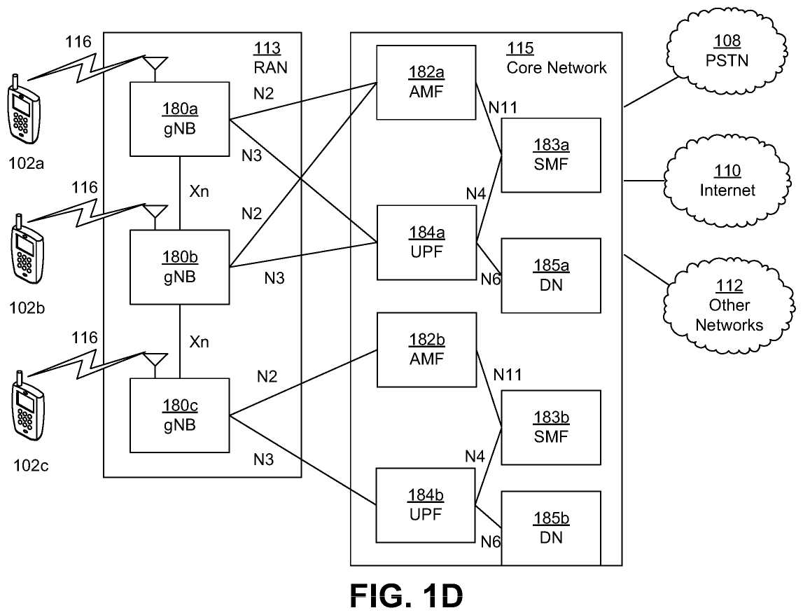

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless transmit/receive unit (WTRU) may comprise a processor and memory. The WTRU may be configured to send a registration request to a hosting network. The registration request may indicate at least one local service. The WTRU may receive a list of equivalent hosting networks for the at least one local service and a common tracking area identity (TAI) list for the list of equivalent hosting networks for the at least one local service. The WTRU may reselect between cells corresponding to equivalent hosting networks from the list of equivalent hosting networks without performing location updates based on the cells being associated with the common tracking area identity list. The WTRU may receive a registration accept message. The registration accept message may comprise the list of equivalent hosting networks for the at least one local service and the common tracking area identity list for the list of equivalent hosting networks for the at least one local service.

During cell reselection, a WTRU may change from one cell to another cell, and in some instance, stay in IDLE mode. For instance, the WTRU may be camped on (e.g., registered with) one cell (e.g., only one cell). When the WTRU determines that another cell is preferred (e.g., based on a measured signal strength of another cell), the WTRU may change to the other cell (e.g., and stay in IDLE mode). For example, the WTRU may reselect to a cell corresponding to an equivalent hosting network from the list of equivalent hosting networks based on a respective priority of each of the equivalent hosting networks (e.g., and/or based on measured signal strength of the other cell). Accordingly, during cell reselection, the WTRU may connect to a cell (e.g., of an equivalent hosting network) that has the best conditions among all the cells to which the WTRU is allowed to camp on.

The WTRU may receive a plurality of lists of equivalent hosting networks. Each of the lists of equivalent hosting networks of the plurality of lists of equivalent hosting networks may be associated with a respective one or more local service. The hosting network may comprise one of a register public land mobile network (RPLMN), a home public land mobile (HPLMN), or an equivalent HPLMN.

Network selection is a process whereby a WTRU may perform a radio scan to check the availability of networks associated with different cellular network cells. The networks detected from such as scan may include SNPNs at its current frequency. The WTRU may attempt to register to an SNPN, for example, upon detecting the SNPN(s). The WTRU may select a registered SNPN (e.g., if available) using NG-RAN access technology, and perform a registration procedure, for example, when the WTRU is turned on or following recovery from lack of coverage. The WTRU may scan one or more RF channels in NR bands to find available SNPNs. The frequencies and/or RF channels to be searched or scanned may depend on the hardware capabilities of the WTRU and/or its network configuration. For a given carrier, the WTRU may search for the strongest cell and read the strongest cell's system information in order to find out which SNPN(s) the cell belongs to. The WTRU may perform one or more procedures, depending on its SNPN selection mode, for example, if there is no registered SNPN, or registration is not possible due to the SNPN being unavailable or registration failure.

In order to optimize mobility procedures (e.g., limit the number of type of communications between the WTRU and the network, reduce radio usage, ensure power savings at the WTRU, etc.), the WTRU may be configured to implement techniques and procedures that limit the amount of signaling exchanged with the network when performing mobility procedures that result in a change in SNPN. For example, the WTRU may be configured to implement the Idle mode and/or the connected mode mobility procedures that do not involve invoking new network selection or network registration procedures. For example, a WTRU may prioritize mobility to a cell associated with a previously registered SNPN and/or a cell associated with an equivalent SNPN to the previously registered SNPN. The WTRU may be able to transition to the new cell without having to perform a network selection or network registration procedure with a core network node. For example, the WTRU may be able to transition to the new cell without having to perform a network selection or network registration procedure with a core network node by prioritizing mobility to a cell associated with a previously registered SNPN and/or a cell associated with an equivalent SNPN to the previously registered SNPN. The WTRU may implement procedures design to facilitate mobility without the use or performance of new network scans to check availability of SNPNs at a current location. Disclosed herein are example techniques for implementing such schemes by a WTRU.

One or more mechanisms to support equivalent hosting networks, and/or to ensure idle and connected mode mobility between hosting networks may be disclosed herein. SNPN selection and reselection based on SNPN priority (e.g., hosting network priority) may be disclosed herein.

A WTRU may support one or more equivalent stand-alone non-public networks (eSNPNs). For example, equivalent eSNPNs may be regarded as equivalent by the WTRU for the purposes of SNPN selection, cell selection/re-selection, and/or handover. Idle and/or connected mode mobility may be performed between equivalent SNPNs without new network selections.

eSNPNs may be pre-configured in the WTRU or provided to the WTRU via NAS signaling during registration (e.g., initial, mobility, and/or periodic) procedures, or via another NAS signaling message (e.g., Configuration Update Command, WTRU Parameter Update procedure via UDM, Steering of Roaming (SOR) container, etc.)

A subscribed SNPN may be an SNPN for which the WTRU has a subscription. The SNPN identity of the subscribed SNPN of the selected entry of a list of subscriber data may identify the subscribed SNPN. For example, the list of subscriber data may be information with details about the subscription information of the SNPN. The WTRU may store the list of subscriber data. eSNPNs may be maintained per subscribed SNPN. As a list of subscriber data may have more than one subscribed SNPN, there may be more than one eSNPN list stored in the WTRU.

SNPN selection may take the equivalent SNPN list into account. When a WTRU performs SNPN selection (e.g., when the WTRU is powered on), the WTRU may check if there is any available SNPN that is among the equivalent SNPN list of the last registered SNPN, if the last registered SNPN is not available. If an equivalent SNPN of the last registered SNPN is available, the WTRU may select the equivalent SNPN of the last registered SNPN over other available SNPNs that may be in the WTRU's list of subscriber data. For example, if the WTRU detects or identifies a cell associated with an equivalent SNPN of its last registered SNPN, cells associated with this equivalent SNPN may have higher priority than other cells associated with other SNPNs that are not equivalent to the last registered SNPN and/or other SNPNs in the WTRU's list of subscriber data. For example, if multiple SNPNs in the equivalent SNPN list are found, a SNPN may be selected according to the priorities of those multiple SNPNs. The WTRU may receive the priorities of the equivalent SNPNs in the equivalent SNPN list received from the core network (e.g., AMF).

The WTRU may select the cell that belongs to an equivalent SNPN of the currently registered SNPN over other cells that belong to other subscribed SNPNs in a cell re-selection, even if those other cells have better radio signal strength/quality, for example, if there are multiple better cells of other SNPNs that satisfy the cell re-selection criteria. For example, the cell of an equivalent SNPN may have higher priority than the priority of a subscribed SNPN in terms of cell reselection.

Similarly, the WTRU may select a cell that belongs to an equivalent SNPN of the currently registered SNPN over other cells that belong to other subscribed SNPNs, even if those other cells have better radio signal strength/quality, for example, when the network (e.g., the AMF) selects a target cell for the purpose of handover. For example, the cell of an equivalent SNPN may have higher priority than the priority of a subscribed SNPN in terms of handover.

A hosting network may be a Stand-alone Non-Public Network (SNPN). One or more of the embodiments disclosed herein for the equivalent SNPNs may be extended to the hosting networks addressing supporting equivalent hosting networks and/or ensuring idle and connected mode mobility between hosting networks. For example, the WTRU may treat the equivalent hosting networks as equivalent for the purpose of hosting network selection, cell selection/re-selection and/or handover.

The hosting networks may provide various localized services. The equivalent hosting networks may be linked with a unique type of localized service that are provided by the hosting networks, identified by the local service identifier. For example, equivalent hosting networks may be indexed via the localized service they are providing, with validity which is linked with time and location. For example, the hosting network may be valid (e.g., only) during a time validity period and for specific location(s) (e.g., tracking area(s)). The hosting networks that are equivalent to each other may be linked with the type of localized service they provide (e.g., via a localized service identifier).

The WTRU may reselect between cells corresponding to the equivalent hosting networks form the list of equivalent hosting networks based on a respective priority of the hosting networks. The equivalent hosting networks may comprise one or more stand-alone non-public networks (SNPNs) or Hosting networks.

The WTRU may periodically attempt to find a highest priority equivalent hosting network during initial cell selection if the WTRU is not camped on the highest priority equivalent hosting network.

The WTRU may perform location updates comprises any combination of an initial registration at power on, a mobility registration procedure, and/or periodic updates. The initial registration at power on may include a location update and/or an attach procedure. The mobility registration procedure may include one or more of a location update, a routing area update, and/or a tracking area update. The periodic updates may be the periodic updates at expiry of the periodic registration timer. The periodic updates may include a period tracking and/or routing area update procedures.

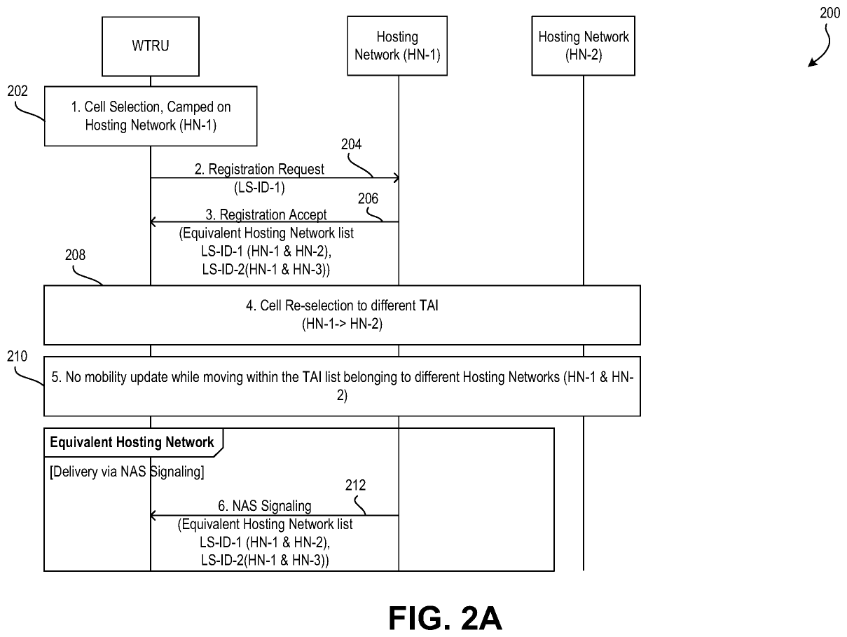

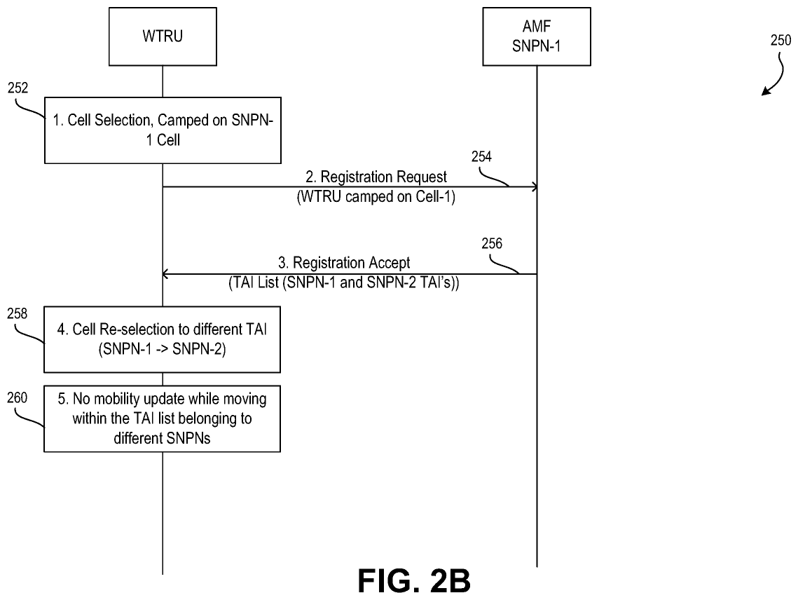

FIG. 2A illustrates an example call flow 200 between equivalent hosting networks. At 202, a WTRU may be camped on a cell of a first hosting network HN-1. As shown in FIG. 2A, the WTRU may select a cell which belongs to a first hosting network HN-1 as part of a cell selection/initial power on/recovery from lack of coverage procedure. The WTRU may trigger a registration procedure with the first hosting network HN-1. For example, at 204, the WTRU may request a localized service identified by the localized service identifier LS-ID-1. At 206, the first hosting network HN-1 (e.g., an AMF (Access and Mobility Management Function) of the first hosting network HN-1) may send a registration accept message to the WTRU. The registration accept message may include a tracking area identifier (TAI) list with TAIs which belongs to equivalent hosting networks along with the supported localized service identifier (e.g., LS-ID-1 for the first hosting network HN1 and a second hosting network HN-2, and LS-ID-2 for the first hosting network HN-1 and a third hosting network HN-3). The equivalent hosting network list may be provided by the registered PLMN (RPLMN), Home PLMN (HPLMN) and/or equivalent HPLMNs during normal registration procedures.

The WTRU may be currently camped on a cell from the first hosting network HN-1 accessing a localized service identified by the LS-ID-1. During the mobility, the WTRU may make a selection for the TAI which is not from the first hosting network HN-1 (e.g., the TAI which belongs to second hosting network HN-2) at 208, for example, based on the reselection criteria. However, the TAI which is not from the first hosting network HN-1 may be a part of the TAI list provided by the first hosting network HN-1. The TAI which is not from the first hosting network HN-1 may belong to an equivalent hosting network and provide localized service identified by the LS-ID-1. As the new TAI is part of the TAI list belonging to the equivalent hosting networks, the WTRU may not trigger a mobility registration procedure. In addition, the WTRU may seamlessly transition to the new TAI (e.g., camped on cell belonging to the new TAI from the second hosting network HN-2, accessing localized service identified by LS-ID-1). The TAIs which are part of the TAI list may be considered registered TAIs belonging to equivalent Hosting Networks. Such mobility registration procedure between the hosting networks may not require the WTRU to trigger a new mobility update procedure.

Alternatively, the 5GC (AMF) may deliver the equivalent hosting network list via NAS signaling messages (e.g., Configuration Update Command, UE Parameter Update procedure via UDM, Steering of Roaming (SOR) container, etc.). For example, at 212, the first hosting network HN-1 may provide the equivalent hosting network list via NAS signaling messages to the WTRU. The NAS signaling messages may include a Configuration Update Command, a WTRU Parameter Update procedure via UDM, and/or an SOR container. Accordingly, in some examples, the WTRU may receive the the equivalent hosting network list via NAS signaling messages (e.g., as shown at 212) instead of via a registration accept message (e.g., as shown at 206). The WTRU may receive the equivalent hosting network list during the registration procedure. For example, the WTRU may receive the equivalent hosting network list via the registration accept message. For example, the WTRU may receive the equivalent hosting network list via the SOR container/CUC procedure.

A tracking area identifier (TAI) list with TAIs from different SNPNs may be used. For example, the TAI list may include the TAIs associated with a first SNPN and the TAIs associated with a second SNPN. The first SNPN and the second SNPN may be equivalent SNPNs. The WTRU may switch between the first SNPN and the second SNPN without performing a mobility registration update procedure.

During a registration procedure, a selected SNPN may provide a WTRU with a list of registered TAIs. The TAI list may include the TAIs belonging to different but equivalent SNPNs. Idle and connected mode mobility between the TAI's may be used without the WTRU performing mobility registration update procedures. The mobility between the TAIs may be seamless from the WTRU perspective. For example, the WTRU may fail to perform radio scans for the network selection process. The TAIs may be considered equivalent for the purpose of cell selection/re-selection, mobility and/or handover.

FIG. 2B illustrates an example call flow 250 that depicts an example usage of a tracking area identifier (TAI) list with one or more stand-alone non-public networks (SNPNs). As shown in FIG. 2B, a WTRU may select a first cell (e.g., cell-1), which belongs to a first SNPN (e.g., SNPN-1), as part of a cell selection procedure at 252. The WTRU may trigger a registration procedure toward the network (e.g., SNPN-1). SNPN-1 and a second SNPN (e.g., SNPN-2) may be equivalent SNPNs. For example, the WTRU may send a registration request to the first SNPN (e.g., an AMF of the first SNPN) at 254.

The network (e.g., SNPN-1) may transmit a registration accept message to the WTRU at 256. In some examples, the registration accept message may include a TAI list with one or more TAIs belonging to both the SNPN-1 and the SNPN-2. The WTRU may receive the registration accept message and the TAI list. The WTRU may be camped on a cell-1 (e.g., SNPN-1) TAI. At 258, the WTRU may perform cell reselection to a different TAI. For example, during mobility, the WTRU may select a TAI that is not from the SNPN-1, but that is part of the TAI list provided by SNPN-1, for example, based on the reselection criteria. For example, the selected TAI may belong to the SNPN-2. As the new TAI is part of the TAI list, the WTRU may not trigger a mobility registration procedure at 260. The WTRU may transition to the new TAI (e.g., such that the WTRU is camped on the cell belonging to the new TAI) because the new TAI is part of the TAI list. The TAIs which are part of the TAI list may be considered registered TAIs belonging to equivalent SNPNs. Mobility between the registered TAIs may not require a mobility update procedure.

The WTRU may receive an RRC connection release message from a registered hosting network that includes idle mode mobility information. The idle mode mobility information may comprise a list of carrier frequencies or an operating frequency band that belongs to the equivalent hosting networks. The WTRU may perform trigger cell selection or reselection based on a determination that a target frequency from the list of carrier frequencies meets cell selection and re-selection criteria.

NR RRC Connection release with idle mode mobility information may be performed. For example, a WTRU may receive an RRC connection release message from the first hosting network that includes the idle mode mobility information. The idle mode mobility information may include a list of NR carrier frequencies. The idle mode mobility information may include the respective NR bands that belong to equivalent SNPNs. The WTRU may switch between the NR bands without performing a mobility registration procedure.

A registered SNPN may share cell selection and re-selection assistance information via an NR RRC connection release message. The SNPN may provide an additional information element along with the NR RRC connection release message (e.g., idle mode mobility information).

An idle mode mobility information element may include a list of NR carrier frequencies, along with an operating NR band that belongs to equivalent SNPNs. The mobility towards these frequencies (e.g., cells) may be performed without the WTRU triggering a mobility registration procedure. The WTRU may use the list of NR carrier frequencies to trigger the cell selection and/or re-selection, provided that the target frequencies meet the cell selection and re-selection criteria.

Table 1 (reproduced below) illustrates sample contents of an idle mode mobility information element.

TABLE 1

| List Item | NR Carrier Frequency | NR Operating Band |
|---|---|---|
| 1 | NR ARFCN-01 | N1 |
| 2 | NR ARFCN-02 | N65 |
| 3 | NR ARFCN-03 | N66 |

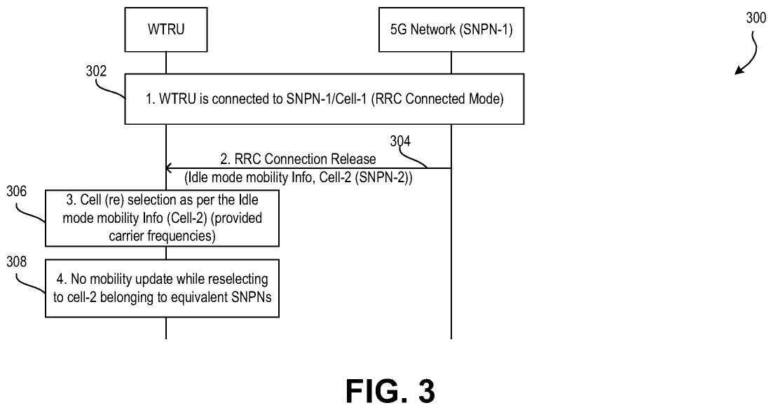

FIG. 3 illustrates an example call flow 300 that depicts an example usage of an RRC connection release with the idle mode mobility information. As shown in FIG. 3 at 302, a WTRU may be camped on a first cell (e.g., cell-1), which belongs to a first SNPN (e.g., SNPN-1), while in the RRC connected mode. The SNPN-1 may be equivalent to a second SNPN (e.g., SNPN-2) for the purposes of network selection, cell selection/re-selection, and/or handover.

At 304, the WTRU may receive an RRC connection release from the 5G network. In some examples, the RRC connection may be released by the 5G network with additional information for cell selection and reselection. At the RRC Connection release, the WTRU may make the transition from the RRC Connected mode to the RRC Idle mode. The RRC Connection release may be provided with additional information (e.g., Idle mode mobility info) for dedicated cell reselection, for example, when providing NR carrier frequencies along with NR band. The additional information may assist the WTRU for the idle mode mobility (e.g., direct cell selection and reselection) without triggering new network selection. For example, the RRC connection release may include Idle mode mobility information that provides dedicated cell reselection priorities (e.g., for a Cell 2 (SNPN-2)) for reselection, for instance, as part of the Equivalent SNPNs.

At 306, the WTRU may perform cell selection (e.g., and/or reselection) based on the Idle mode mobility information (e.g., identifying Cell 2 and/or based on the provided carrier frequencies). The WTRU may trigger Idle mode cell selection (e.g., and/or reselection) based on the RRC Connection release message received from the 5G network. During the process of Idle mode cell selection, while transitioning from RRC connected mode to RRC Idle mode, the WTRU may make use of the additional information provided by the network during the RRC connection release (e.g., Idle Mode Mobility Info). This new additional information element may contain information which assists with cell selection by providing dedicated NR frequencies along with the dedicated NR frequencies' NR Bands. For example, the WTRU may select a cell based on the idle mode mobility information. At 308, as the newly-selected cell is part of the equivalent SNPNs, the WTRU may fail to trigger a mobility update procedure.

SNPN selection and reselection based on priority may be performed.

A registered SNPN or a hosting network may provide a WTRU with a list of prioritized SNPNs or hosting networks based on supported local service. The list of prioritized hosting networks/SNPNs may be stored at the WTRU (e.g., in ME or in universal subscriber identity module (USIM)). The WTRU may ensure that during the initial registration as well as the subsequent periodic attempts at power on or recovery from lack of coverage, the WTRU attempts to select the highest priority SNPN or hosting network for a particular local service. For example, if the highest priority SNPN or hosting network is not available during initial registration, the WTRU may make periodic attempts to look for the highest priority SNPN or hosting network and if available, may attempt to register with the highest priority SNPN or hosting network.

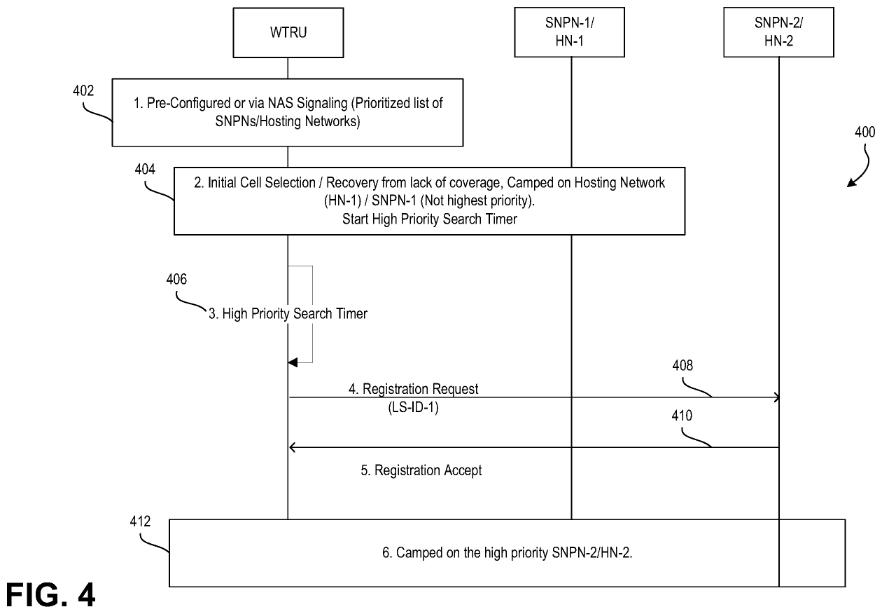

FIG. 4 illustrates an example call flow 400 that depicts an example of SNPN/hosting network selection and reselection based on priority. As shown in FIG. 4 at 402, the WTRU may be either pre-configured with a prioritized list of SNPNs or hosting networks based on localized service, or may receive the additional information from the 5G core network via the NAS signaling messages. At 404, at power on or recovery from loss of coverage, the WTRU may perform the initial scan for available SNPNs/Hosting Networks. At power on or recovery from loss of coverage, the WTRU may select the best (e.g., highest priority) SNPN/Hosting network if available. In the example shown in FIG. 4, the only available SNPN/Hosting network is the SNPN-1/HN-1, which is not the highest priority as per the WTRU configuration. If the WTRU is not camped on the highest priority network, the WTRU may start a periodic search timer to look for higher priority networks at 406.

At the expiry of the periodic search timer, the WTRU may trigger search for higher priority SNPN/Hosting Network. For example, as shown in FIG. 4, at the expiry of the periodic search timer, the WTRU may be able to find the SNPN-2/HN-2 which has a higher priority as compared to the currently registered SNPN/HN (e.g., SNPN-1/HN-1). At 408, the WTRU may trigger a registration request to SNPN-2/HN-2. The registration request may (e.g., in case of hosting network registration request) contain a local service identifier corresponding to the desired local service. If the registration procedure is successful, the 5G core network may send a registration accept message at 410. The WTRU may then be camped on the highest priority SNPN/Hosting Network (e.g., SNPN-2/HN-2) at 412. If the WTRU is camped on the highest priority network, the WTRU may not start the periodic higher priority search timer.

The processes and instrumentalities described herein may apply in any combination. The process and instrumentalities described herein may apply to other wireless technologies, and for other services.

A WTRU may refer to an identity of the physical device, or to the user's identity such as subscription related identities (e.g., MSISDN, SIP URI, etc.). The WTRU may refer to application-based identities (e.g., user names that may be used per application).

A computer and/or processor may implement the processes described above in a computer program, software, and/or firmware incorporated in a computer-readable medium for execution. Examples of computer-readable media may include, but are not limited to, electronic signals (transmitted over wired and/or wireless connections) and/or computer-readable storage media. Examples of computer-readable storage media may include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed is:

1-20. (canceled)

21. A wireless transmit/receive unit (WTRU) comprising:
a processor and memory, wherein the processor and memory are configured to:
send a registration request to a hosting network, wherein the registration request indicates a localized service;
receive a list of equivalent hosting networks for the localized service and a common tracking area identity list for the list of equivalent hosting networks for the localized service; and
perform cell reselection corresponding to an equivalent hosting network from the list of equivalent hosting networks without performing location updates based on the cells being associated with the common tracking area identity list.

22. The WTRU of claim 21, wherein the processor and memory are configured to:
receive a registration accept message, wherein the registration accept message comprises the list of equivalent hosting networks for the localized service and the common tracking area identity list for the list of equivalent hosting networks for the localized service.

23. The WTRU of claim 21, wherein the processor and memory are configured to:
receive a priority list of equivalent hosting networks; and
perform cell reselection corresponding to an equivalent hosting network from the list of equivalent hosting networks based on a respective priority of each of the equivalent hosting networks as indicated by the priority list of equivalent hosting networks.

24. The WTRU of claim 23, wherein each of the equivalent hosting networks in the received priority list of equivalent hosting networks is associated with a respective localized service.

25. The WTRU of claim 21, wherein the hosting network comprises one of a register public land mobile network (RPLMN), a home public land mobile network (HPLMN) or an equivalent HPLMN, and wherein the equivalent hosting networks are stand-alone non-public networks (SNPNs).

26. The WTRU of claim 21, wherein the localized service is identified by an identifier (ID) of the localized service.

27. The WTRU of claim 21, wherein the processor and memory are configured to:
select a highest priority hosting network during an initial cell selection if the WTRU is camped on the highest priority hosting network; and
periodically attempt to find a highest priority hosting network if the WTRU is not camped on the highest priority hosting network.

28. The WTRU of claim 21, wherein the processor and memory are configured to:
receive a radio resource control (RRC) connection release message from a registered hosting network that comprises idle mode mobility information, wherein the idle mode mobility information comprises a list of carrier frequencies that are used by the equivalent hosting networks or an operating frequency band that is used by the equivalent hosting networks.

29. The WTRU of claim 28, wherein the processor and memory are configured to:
perform cell selection or reselection based on a determination that a target frequency from the list of carrier frequencies meets cell selection criteria or re-selection criteria.

30. The WTRU of claim 21, wherein, based on the cells being associated with the common tracking area identity list, the processor is configured to:
reselect between cells corresponding to equivalent hosting networks from the list of equivalent hosting networks without performing an initial registration at power on, a mobility registration procedure, or periodic updates.

31. A method comprising:
sending a registration request to a hosting network, wherein the registration request indicates a localized service;
receiving a list of equivalent hosting networks for the localized service and a common tracking area identity list for the list of equivalent hosting networks for the localized service; and
performing cell reselection corresponding to an equivalent hosting network from the list of equivalent hosting networks without performing location updates based on the cells being associated with the common tracking area identity list.

32. The method of claim 31, further comprising:
receiving a registration accept message, wherein the registration accept message comprises the list of equivalent hosting networks for the localized service and the common tracking area identity list for the list of equivalent hosting networks for the localized service.

33. The method of claim 31, further comprising:
receiving a priority list of equivalent hosting networks; and
performing cell reselection corresponding to an equivalent hosting network from the list of equivalent hosting networks based on a respective priority of each of the equivalent hosting networks as indicated by the priority list of equivalent hosting networks.

34. The method of claim 33, wherein each of the equivalent hosting networks in the received priority list of equivalent hosting networks is associated with a respective localized service.

35. The method of claim 31, wherein the hosting network comprises one of a register public land mobile network (RPLMN), a home public land mobile network (HPLMN) or an equivalent HPLMN, and wherein the equivalent hosting networks are stand-alone non-public networks (SNPNs).

36. The method of claim 31, wherein the localized service is identified by an identifier (ID) of the localized service.

37. The method of claim 31, further comprising:
selecting a highest priority hosting network during an initial cell selection if a wireless transmit/receive unit (WTRU) is camped on the highest priority hosting network; and
periodically attempting to find a highest priority hosting network if the WTRU is not camped on the highest priority hosting network.

38. The method of claim 31, further comprising:
receiving a radio resource control (RRC) connection release message from a registered hosting network that comprises idle mode mobility information, wherein the idle mode mobility information comprises a list of carrier frequencies that are used by the equivalent hosting networks or an operating frequency band that is used by the equivalent hosting networks.

39. The method of claim 38, further comprising:
performing cell selection or reselection based on a determination that a target frequency from the list of carrier frequencies meets cell selection criteria or re-selection criteria.

40. The method of claim 31, wherein, based on the cells being associated with the common tracking area identity list, further comprising:
reselecting between cells corresponding to equivalent hosting networks from the list of equivalent hosting networks without performing an initial registration at power on, a mobility registration procedure, or periodic updates.
